(19) United States
(12) Patent Application Publication
(10) Pub. No.: US 2002/0066199 A1
(43) Pub. Date: Jun. 6, 2002

(54) Picture frame hanger with integral spirit level and toothed bracket

(76) Inventor: Larry Keith Hanson, Los Alamitos, CA (US)

Correspondence Address: Larry K. Hanson, 2731 Tucker Lane, Los Alamitos, CA, 90720, US

(21) Appl. No.: 09/728,897

(22) Filed: Dec. 2, 2000

(51) Int. Cl. G01C 9/00

(52) U.S. Cl. 33/613

(57) ABSTRACT

An improved hanging device for wall mounted objects such as pictures, mirrors and displays featuring a built in spirit level vial (6) for leveling purposes and an integral toothed bracket (8) for engaging a fastener (28) on or in the wall upon which the object is to be suspended. Alternative embodiments feature devices for the same use and purpose which utilize the same operating principle enabling utilization of different materials and methods of construction.

### CROSS REFERENCE TO RELATED APPLICATIONS

Not applicable

### BACKGROUND—FIELD OF INVENTION

This invention relates to a picture frame hanger containing a spirit level to aid in installing picture frames in a square and level condition and a means for keeping the frames in that condition. The invention also embodies a toothed hanging bracket which is an integral part of the hanger.

### BACKGROUND—DESCRIPTION OF PRIOR ART

Most framed pictures and some other hanging objects such as mirrors, are held in place on a wall by a wire attached to the frame which is then looped over a nail or screw imbedded in the wall. After the frame has been suspended in this manner, it is leveled by eye. Even though a carpenter's level may be used for leveling purposes, the picture frame can easily be skewed due to wall vibration, accidental contact during cleaning and inadvertent contact by passersby. After each of the above type events, the frame is re-leveled by eye or, perhaps, left in a skewed state.

Another common practice is the attachment to the top of the frame of a toothed bracket having a plurality of teeth. In this method of mounting, the toothed bracket engages a screw or nail imbedded in a wall, after which the picture is moved to the appropriate tooth/groove which by eye, enables the picture to assume a level condition. This method has the same weaknesses as wire hanging.

Yet another mounting method employs use of two imbedded screws from which a wire attached to the picture is looped over both. With the picture suspended in this manner, it is adjusted by eye to a level condition. This method of hanging presents a cumbersome mounting process which often requires re-leveling due to wall movement or inadvertent human or other incidental contact.

Frequently, framed objects are permanently fastened to a wall using a minimum of two fasteners. During the mounting process, a carpenter's level is normally used to attain an acceptable degree of levelness. Permanent mounting overcomes the problem of skewing but is a difficult task to accomplish by a single individual. Further, moving pictures which have been mounted in this manner creates greater wall damage than other methods of picture hanging.

There are several picture frame wall mounting systems which are designed to enable a framed object to slide up and down a rod or cable during the process of locating and leveling frames. These systems tend to be complex and expensive, often requiring the service of an experienced installer.

Finally, there are turnbuckle type products which can be applied to a conventional single or double frame hanging wire. After a picture frame has been installed using this method, the turnbuckle/s is twisted changing wire length until the frame appears level.

### SUMMARY

In accordance with the current invention a picture frame hanger possessing an integral spirit level and toothed bracket which is installed onto a picture frame or similar object with the ensuing assembly then being suspended from a fastener attached to or embedded in a wall.

Objects and Advantages

Accordingly, besides the objects and advantages of my picture frame hanging device described in my above patent, several advantages of the present patent are:

(a) to provide a picture frame hanging method which is simple and easy to install by one person;

(b) to provide a method of making absolutely sure that upon initial installation, the picture frame will be accurately level;

(c) to provide a method of picture hanging which can be accomplished by an individual with minimal manual skills using very basic hand tools;

(d) to provide a simple method of re-leveling picture frames which may become skewed due to careless contact or wall vibration;

(e) to provide a method of picture hanging which insures level mounting in the event a framed picture already incorporating my invention is moved to another location;

(f) to provide a simple method for suspending mirrors and hanging items other than picture frames:

(g) to provide a method for hanging certain styles of wall mounted clocks which must be level in order to yield accurate time:

### DRAWING FIGURES

In the drawings, closely related figures have the same numbers but different alphabetic suffixes.

FIGS. 1A to 1E illustrate one method of the invention's construction while 1F is a perspective view of this construction showing the invention as it would appear as mounted on a typical picture frame.

FIGS. 2A and 2B show the invention incorporating the same principles and method of use as depicted in FIGS. 1A to 1E but featuring a different form of construction. The picture level as shown in FIGS. 2A and 2B would be mounted on a picture frame in the same manner as depicted in FIG. 1E with the exception FIGS. 2A to 2C have mounting wings as depicted in FIGS. 2A to 2C.

FIGS. 3A to 3D utilize the same principles as shown in FIGS. 1A to 1E yet feature another type of construction while FIG. 3E shows in perspective, the invention as it would be mounted on a typical picture frame using mounting wings as described in FIGS. 2A to 2C.

FIGS. 4A to 4C depict another construction method, utilizing the same principles as shown in FIGS. 1A to 1E.

Reference Numerals In Drawings

6 Spirit level vial

8 mounting bracket

10 vial housing

12 vial viewing port

14 mounting screw slots

16 mounting screws

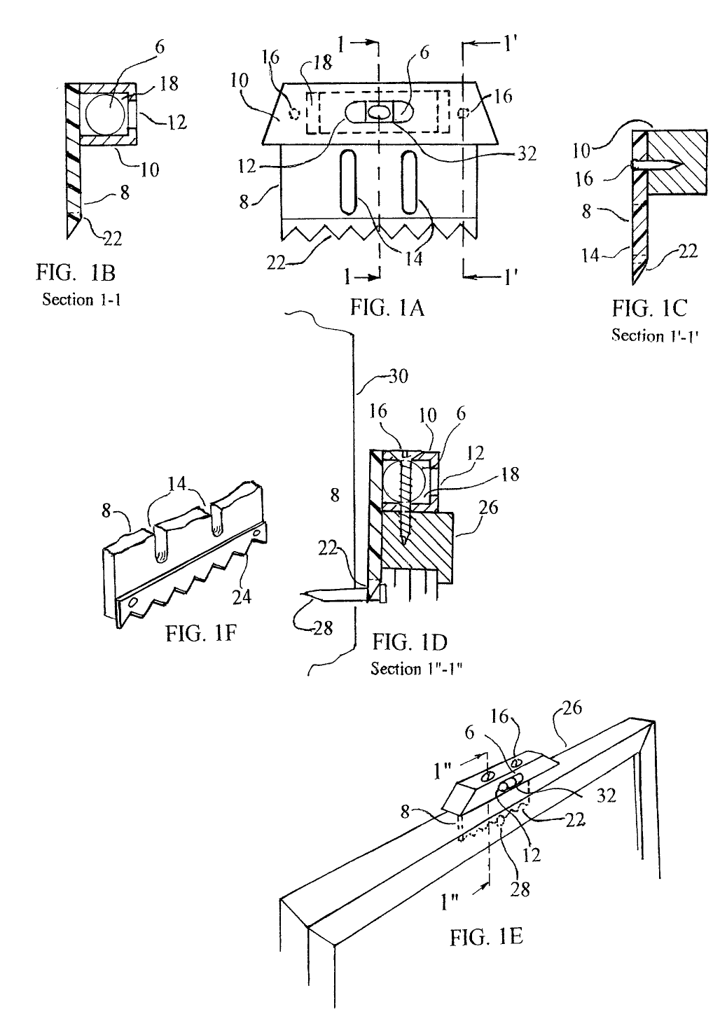

### DESCRIPTION—FIGS. 1A, 1B, 1C and 1D—Preferred Embodiment

A preferred embodiment of the present invention is illustrated in front view FIG. 1A and section 1-1 shown in FIG. 1B. The picture level has a spirit level vial 6 which has a round cross-section with bubble centering lines 32 both left and right of the vertical line delineating section 1-1. In this embodiment, the vial housing 10 is made of wood; either from a solid piece of that material or from laminations which contain a cavity 18 of a size to accept the spirit level vial 6. The front cover 20 of the vial housing 10 is constructed from a suitable wood veneer or some other thin material, having a centrally located viewing port 12 cut in it which gives view to the spirit level vial 6 inside the housing 10.

The reverse or backside of vial housing 10 is closed off by the mounting bracket 8, a thin piece of plywood or similar material which has good strength characteristics in its vertical plane. Mounting bracket 8 is secured to vial housing 10 by suitable fasteners 16. The top of mounting bracket 8 is flush and square with respect to the top of vial housing 10. Mounting bracket 8 extends vertically downward terminating in a serrated or toothed end surface 22. An alternative to toothed surface 22 is use of a separate toothed metal bracket 24, FIG. 1F, which can be affixed to the lower end of mounting bracket 8.

Mounting bracket 8 has fastener slots 14 which are used to attach mounting bracket 8 to the back of a picture frame 26 as shown in FIG. 1D. Use of slots accommodates frames 26 of varying cross-sections.

Visible portions of the invention such as the exterior of vial housing 10, may be dyed, painted, coated or finished in some other manner consistent with picture frame decor or personal taste.

In its final assembled form, the picture level is centrally located on picture frame 26 as shown in FIG. 1E and firmly fastened to frame 26 with fasteners 16. In this manner the weight of the picture and its frame, are supported by the combined strength of 4 fasteners 16.

Finally, the framed picture or object with its picture level secured in place is suspended from a fastener 28, FIG. 1D, which is attached in some manner to the wall 30 upon which it is mounted.

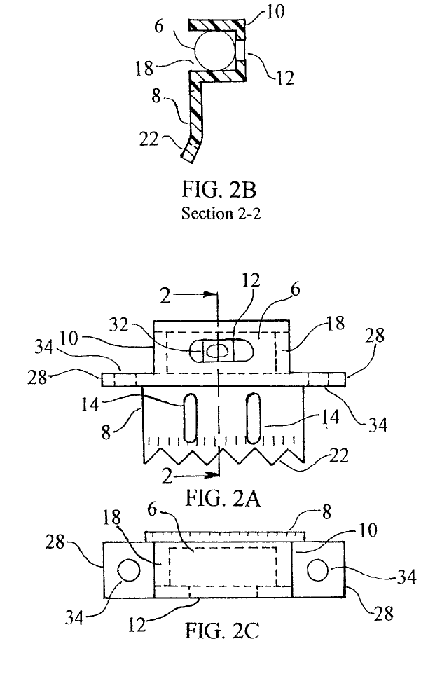

FIGS. 2A, 2B, 2C

FIG. 2A is a front view of my invention constructed from a single piece of material as it would be if the picture level were molded or extruded from some suitable material. FIG. 2B, section 2-2 shows the picture level with a spirit level vial in place, and having a mounting bracket with mounting teeth and fastener slots. FIG. 2C is a plan view of this embodiment showing mounting wings containing fastener holes. Using this method of construction, the invention could be pigmented or coated with colors meeting picture frame artistic requirements. Similarly, metal versions of this embodiment could be plated, coated or otherwise treated to satisfy esthetics.

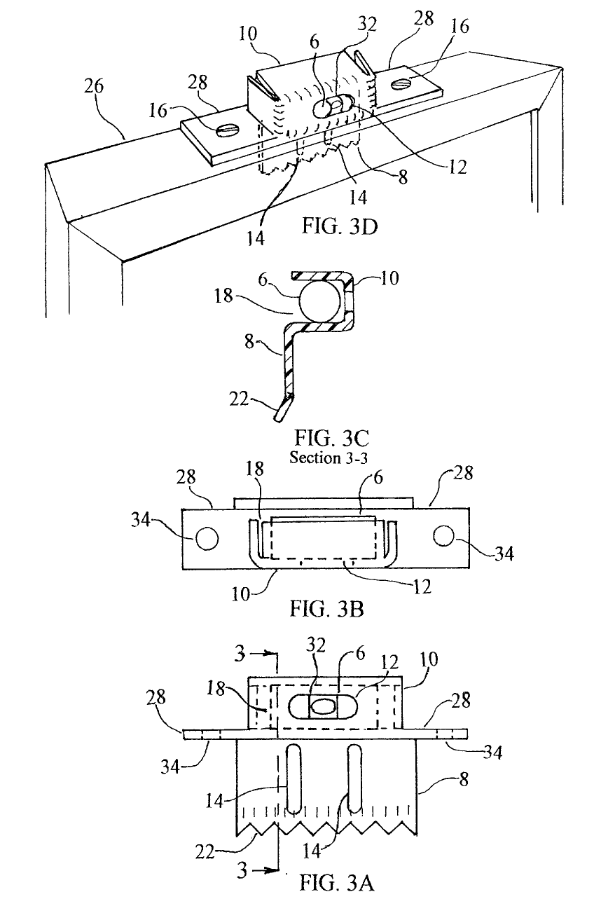

FIGS. 3A, 3B, 3C, 3D—Alternative Embodiments

A third embodiment of my invention is shown in FIGS. 3A, 3B, 3C, 3D. FIGS. 3A and 3B are front and plan views, respectively of a this embodiment which employ the use of soft materials such as brass, aluminum or mild steel, stamped or otherwise formed into a shape as illustrated. The material thickness shown in FIGS. 3A, 3B, C, D has been exaggerated for purposes of illustrative clarity. FIG. 3A shows a plurality of fastening slots 14 in the mounting bracket 8 portion of this single piece construction. FIG. 3C is a section, 3-3, through the center of front view 3C with a spirit level vial surrounded by its housing which contains a viewing port similar to those shown in preceding embodiments.

FIGS. 3B and 3C show mounting wings 28 containing a plurality of holes 34 to enable use of fasteners for the purpose of attaching the picture level to a picture frame.

FIG. 3D is a perspective view showing this invention embodiment as it would appear installed upon a picture frame.

Another Embodiment

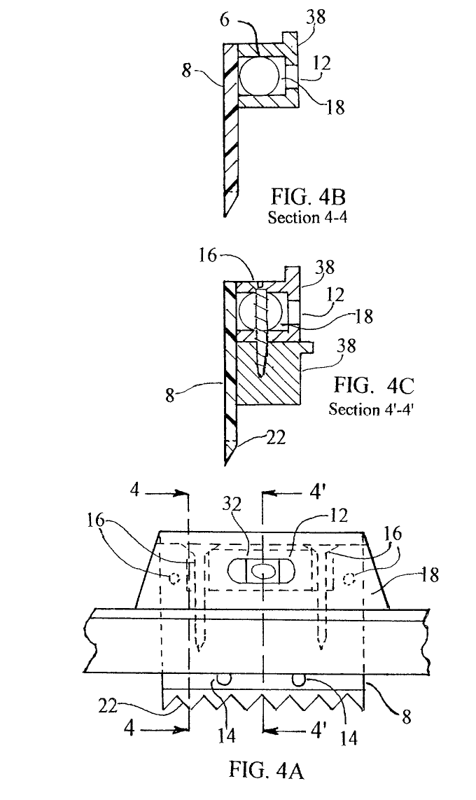

FIGS. 4A, 4B, 4C depict a method of construction similar to that shown in FIGS. 1A, 1B, 1C, 1E, 1D with the exception that vial housing 10 would be constructed from picture frame molding 38 as shown in FIG. 4B, section 4-4 and mounted as shown in FIGS. 4C, section 4′-4′.

Advantages

From the descriptions above, a number of advantages of my picture level hanger become evident:

(a) Integration of a permanent, visible, leveling source in the form of a spirit level vial enables owners or users of framed objects utilizing my invention to easily keep that object in a level condition on a continuing basis.

(b) Wall mounting of a framed object can easily be accomplished by one person utilizing simple hand tools.

(c) When properly installed on a picture frame or other hanging object, that frame or object will be level within fifty-eight arc minutes, a degree of accuracy better than is achievable in leveling by eye alone.

(d) An integral toothed mounting bracket adds to the picture level's versatility while simultaneously reducing picture hanging cost and complexity.

(e) Use of my picture level reduces potential wall damage as there is less need to move objects incorporating my invention.

(f) Framed artwork is frequently hung in clusters within close proximity of each other. Use of my invention mounted on only one frame in such a cluster, greatly aids in keeping all the objects in the cluster square and level with respect to one another.

(g) Incorporation of my invention on certain types of wall hanging clocks aids in improving their accuracy by assisting keeping such time pieces level.

(h) Installation of my invention on wall hanging works of art can improve the artistic quality of the work.

(i) After a picture frame or object has been wall mounted and becomes skewed due to a variety of reasons, it can be very quickly, easily and accurately re-leveled by a lone individual.

(j) My invention will support a great deal of weight due to use of four fasteners installed in two separate vertical planes, thus gaining mounting strength in both tension and shear.

Operation—FIGS. 1, 2, 3, 4

The manner of using my invention on picture frames and similar hanging objets is shown in the preferred embodiment FIG. 1C, 1D ,1E. The flat, bottom surface of vial housing 10 is centrally located on the top surface of a picture frame 26 with mounting bracket 8 firmly in contact through its entire width to picture frame 26. With the picture level thus positioned it is affixed to frame 26 with two fasteners 16. With the picture level mounted in this, its intended manner, the bubble 32 in spirit level vial 18 will center itself when picture frame 26 is hand adjusted to a level state. The principles of operation for embodiments shown in FIGS. 2A, 2B, 2C, 3A, 3B, 3C, 3D, 4A, 4B, 4C, are the same as those described for embodiment 1A, 1B, 1C, 1D.

Conclusions, Ramifications, and Scope

Accordingly, the reader will see that mounting this invention upon a picture frame or other hanging objects such as mirrors, shelves and clocks is a simple operation easily accomplished by one person even though that individual may be unskilled in use of hand tools. Furthermore, the picture level has the additional advantages in that

o it has a spirit level vial which when its bubble is properly centered, has an accuracy of fifty-eight arc minutes, a degree of angularity beyond the viewing capability of the human eye;

o it facilitates simple, accurate re-leveling after initial installation should the picture frame become skewed;

o it embodies a method of frame attachment which is extremely sturdy and capable of holding a considerable amount of hanging weight;

o it enables use of a wide selection of colors and finishes due to its construction and materials;

o it reduces potential for wall damage in that it requires only a single wall fastener from which it is suspended and, immediate achievement of an actual level condition reduces the tendency to change wall locations;

o it improves results and appearance of pictures hung in clusters in that the presence of one truly level picture frame in a cluster enables other pictures in that grouping to use the picture level equipped framed picture as a gauge of levelness;

o it does not detract from the artistic quality of the picture upon whose frame it is mounted;

o it improves the time accuracy of wall mounted clocks upon which it is mounted;

Although the description above contains many specfities, these should not be construed as limiting the scope of the invention but as merely presenting illustrations of some of the presently preferred embodiments of this invention. For instance the picture level can have other shapes such as a vial housing whose front view would be in the form of an arc of a circle, a mounting bracket shaped like a truncated triangle, the vial housing cover with its elliptically shaped window could be eliminated leaving the entire spirit level vial open to view, etc.

Thus the scope of the invention should be determined by the appended claims and their legal equivalents, rather than by the examples given.

I claim:

1. A surface mounting device of the type incorporating a spirit level vial contained in an enclosure offering view to said vial wherein said vial's central axis is maintained parallel to the undersurface of aforesaid enclosure.

2. The enclosure of claim 1 wherein it is attached by suitable means to a mounting bracket.

3. The mounting bracket of claim 2 having slots for accommodating fasteners.

4. The mounting bracket of claim 2 possessing at its lower extremity a plurality of teeth.

5. The said mounting device of claim 2 in its assembled state providing means for attachment to a surface parallel to aforementioned vial's central axis.

6. The surface mounting device of claim 1 composed of a single piece of thin material folded permanently in such a manner as to form a housing containing a spirit level vial wherein said housing enables view of aforesaid spirit level vial with the lower surface of said housing being parallel to the central axis of aforementioned spirit level vial with a plurality of wings extending outward from said housing with each wing containing holes for fastener attachment to an adjoining surface of the object to which it is to be mounted upon.

7. The singular piece of material of claim 5 is further permanently folded into a bracket which in one plane is perpendicular to aforesaid wings and in its. other plane parallel to aforesaid spirit level vial's central axis with said bracket containing mounting slots enabling use of additional fasteners for attachment onto an adjoining object upon which it is to be mounted.

8. The bracket component of claim 5 possessing at its lower extremity a plurality of teeth.

9. The said surface mounting device of claim 5 in its final form enabling mounting on a surface parallel to the central axis of aforementioned spirit level vial.

10. The surface mounting device of claim 1 composed of a singular piece of suitable material having a U shaped housing component open at its back side containing a spirit level vial whose central axis is parallel to the housing cavity in which it is contained said spirit level vial being visible through a viewing port centrally positioned in the closed end of aforesaid U.

11. The said closed end U shape containing wings extending outward on either extremity of aforesaid U shaped housing in a similar manner as stated in claim 6 with said wings having a plurality of fastener mounting holes in a manner similar to claim 6.

12. The said housing and wings having a bracket similar in design and function to claims 5 and 6.

13. The thicker material sections of the embodiment as described in claims 10, 11,12 enable its construction to utilize materials which, typically, can be extruded or molded.

14. The opening on the back side of said housing capable of being sealed off in its entirety with a thin strip of material separate from described singular piece construction of claims 10,11,12.

15. The surface mounting device of claim 1 similar in all respects to said claim with the exception that its housing being fabricated from a short length of the identical molding material upon which it is mounted.
